(19) United States
(12) Patent Application Publication
(10) Pub. No.: US 2019/0156182 A1
(43) Pub. Date: May 23, 2019

(54) DATA INFERENCE APPARATUS, DATA INFERENCE METHOD AND NON-TRANSITORY COMPUTER READABLE MEDIUM

(71) Applicant: Preferred Networks, Inc., Tokyo (JP)

(72) Inventors: Shinichi Maeda, Tokyo (JP); Masanori Koyama, Tokyo (JP)

(21) Appl. No.: 16/174,917

(22) Filed: Oct. 30, 2018

(30) Foreign Application Priority Data
Oct. 30, 2017 (JP) 2017-209674

(51) Int. Cl. G06N 3/04; G06N 3/08; G06K 9/62; G06K 9/46

(52) U.S. Cl. CPC G06N 3/0472; G06K 9/4642; G06K 9/6262; G06N 3/08

(57) ABSTRACT

A data prediction apparatus includes a memory and processing circuitry coupled to the memory configured to (1) receive the target data on which to make inference, (2) extract a neighborhood data group that is a set of data points in supervised data that are similar to the target data, (3) generate a local model by performing local and regularization learning using the neighborhood data group, and (4) make inference on the target data by using the local model.

### CROSS REFERENCE TO RELATED APPLICATIONS

This application is based upon and claims the benefit of priority from the prior Japanese Patent Application No. 2017-209674, filed on Oct. 30, 2017, the entire contents of which are incorporated herein by reference.

### FIELD

The embodiments of the present invention relate to a data inference apparatus, data inference method and non-transitory computer readable medium.

### BACKGROUND

A deep neural network (DNN) has achieved results that have never been possible in various fields by learning using big data. However, learning of a huge DNN takes a huge amount of time, and optimization is difficult without devising a structure like ResNet or resorting to a learning algorithm like Adam or batch standardization. Meanwhile, in many problems, true distribution can be described locally using a simple model. There are therefore methods that make inference for the target data by applying a simple model (typically, a linear model) trained on the set of local data points in the neighborhood of the target. However, such method is prone to overfitting because it uses only small number of data.

### BRIEF DESCRIPTION OF THE DRAWINGS

FIG. 1 schematically illustrates an outline of data estimation according to an embodiment;

FIG. 2 is a block diagram illustrating functions of a data prediction apparatus according to the embodiment;

FIG. 3 is a flowchart illustrating processing of the data prediction apparatus according to the embodiment; and

FIGS. 4A to 4F are examples of data input/output of the data prediction apparatus according to the embodiment.

### DETAILED DESCRIPTION

Embodiments will now be explained with reference to the accompanying drawings. The present invention is not limited to the embodiments. According to one embodiment, a data prediction apparatus includes a memory and processing circuitry coupled with the memory configured to receive target data to be estimated, extract from a set of supervisory dataset a set of data that are similar to the target data, generate a local model by performing local and regularized learning using the set of neighborhood (similar) data, and uses the local model to make inference on the target data.

In the present embodiment, instead of performing estimation using a fixed learning model trained on the entire set, a local learning model is trained on demand for the data to be inferred (estimated), and inference (estimation) is performed using the trained local learning model.

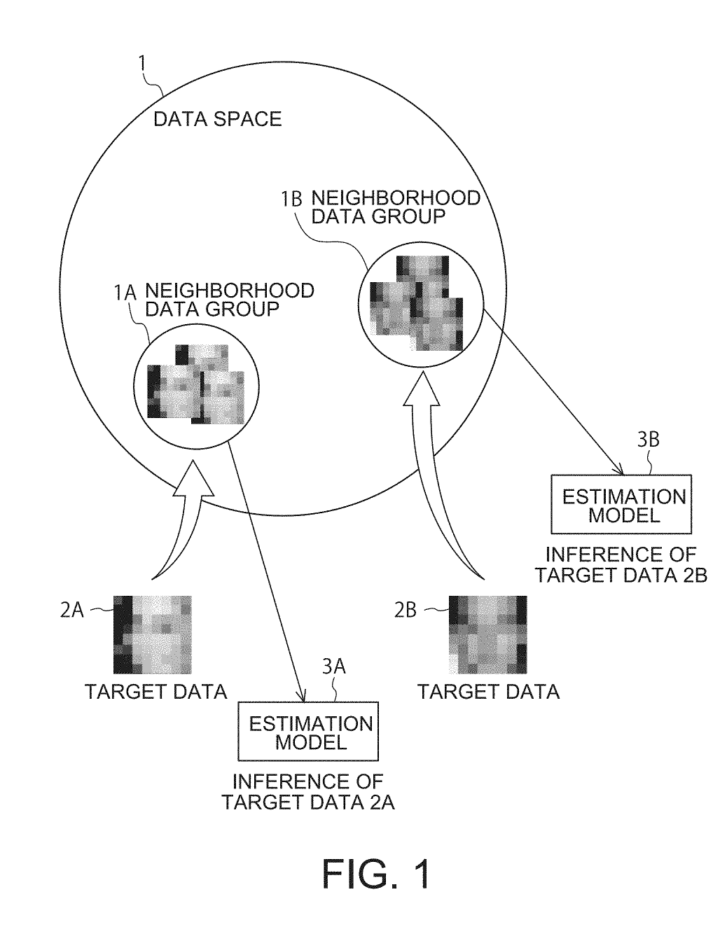

FIG. 1 is a diagram illustrating an outline of learning and an inference model according to the present embodiment. The whole (often large) supervised data are stored in a data space 1. The whole supervised data is, for example, so-called big data, and the data space 1 may be provided in a form of one server machine, or in a form of a set of separate spaces scattered across various places via the Internet or the like.

As an example, super resolution will be described in which a high-resolution image of 32×32 pixels is constructed for a target low-resolution data of 8×8 pixels. When target data 2A is the input, data group 1A including of a set of neighborhood data that are similar to the target data 2A is a part of the data space 1.

A learning apparatus according to the present embodiment obtains a local inference model 3A by conducting a training process on the data group 1A. Then, the target data 2A is passed to the inference model 3A, whereby a super-resolution image of the target data 2A is produced as an output. Thus, for every instance of the input target data, a learning process, estimation process, and the output evaluation are all conducted on demand after receiving the input.

For example, when another target data 2B is input, another data group 1B including a set of neighborhood data that are similar to the target data 2B is extracted from the data space 1, and an estimation model 3B that is different from the inference model 3A is obtained by conducting a training process on the data group 1B. Then, the target data 2B is used as an input to the estimation model 3B, whereby a super-resolution image of the target data 2B can be obtained.

Since the data groups 1A and 1B belong to different data groups, the obtained inference models 3A and 3B are also different models. As described above, inference models are obtained on demand by training on the local data, and inferences are performed separately for every different target data.

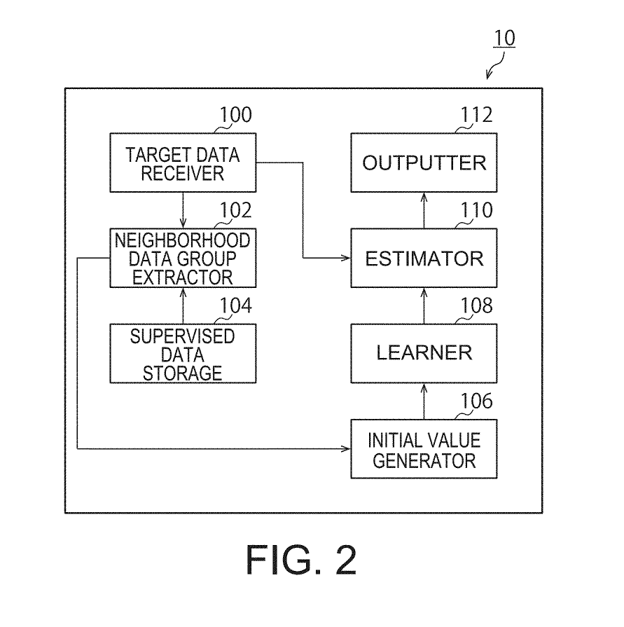

FIG. 2 is a block diagram illustrating the functions of data-prediction apparatus 10 according to the present embodiment. The data-prediction apparatus 10 includes a target data receiver 100, a neighborhood data group extractor 102, a supervised data storage 104, an initial value generator 106, a learner 108, an estimator 110, and an outputter 112.

The target data receiver 100 is an interface that receives the target data to be inferred (estimated). The target data receiver 100 passes the received target data to the neighborhood data group extractor 102.

The neighborhood data group extractor 102 extracts the neighborhood data on the basis of the input target data. The neighborhood data is a set of supervised data in the supervised data storage 104 that are similar to the target data. The neighborhood data group extractor 102 extracts plural data from the supervised data storage 104 based on a set of appropriate predetermined conditions.

The supervised data storage 104 stores plural supervised data. The supervised data storage 104 corresponds to the data space 1 in FIG. 1. As described above, the data may be stored collectively in one server, or may be distributed and stored in plural places via the Internet or the like.

Depending on the type of target data, the neighborhood data group extractor 102 may refer to another instance of data space 1. For example, when a super resolution task is to be performed, an instance of data space 1 storing supervised data of super resolution is referred, and when inference on other types data is to be performed, such as those pertaining to character recognition and speech recognition, other instances of data space 1 storing the data of corresponding types will be referred. Of course, there may be a data space 1 that includes a data of plural types including the type of data to be inferred.

The initial value generator 106 uses the training data to generate an initial value of a network prior to the training process. Generation of the initial value is executed by, for example, a simple model that is simpler in comparison to the model to be used by the learner 108. Typically, a linear model is used as a learning model to generate its initial value. In the case of super resolution, as an example, basis vectors and initial values of their weights are generated by principal component analysis on a high-resolution image included in the neighborhood data group 1A similar to the target data 2A.

The learner 108 obtains an inference model by learning from the extracted or generated neighborhood data group. Since the target apparatus only requires a local model to make inference on local data, the inference model to be constructed by the learner 108 may be trained by a simple method while avoiding overfitting.

The estimator 110 obtains an estimated (inferred) value from the target data received by the target data receiver 100 on the basis of the estimation model trained by the learner 108.

The outputter 112 outputs the estimated value (inferred value) estimated by the estimator 110. The output may be displayed on a screen or the like, or may be printed by a printing machine, or may be output from a speaker or the like in the case of audio data.

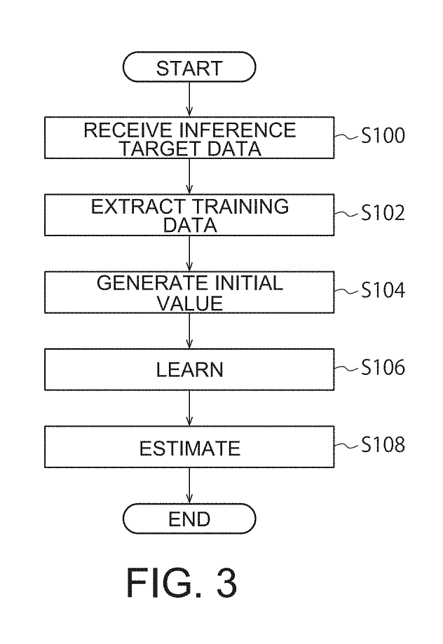

FIG. 3 is a flowchart illustrating a flow of processing of the data prediction apparatus in the present embodiment. Hereinafter, as an example, processing will be described for estimating a super-resolution image of 32×32 pixels from an image of 8×8 pixels as described above, with reference to the flowchart.

First, the target data receiver 100 receives inference target data (step S100). For example, the target data receiver 100 receives an image input from a user via an interface of a computer.

Next, the neighborhood data group extractor 102 extracts from the supervised data storage 104 (step S102) a neighborhood data group including data points that are similar to the target data. When the target data is x* and input data of 8×8 pixels in the data stored in the supervised data storage 104 is xₖ, for example, a set D that satisfies the following equation is extracted.

D_{ε}={(xₖ,yₖ)|d(x*,xₖ)≤ε} (1)

Here, d(x*, xₖ) represents a distance between x* and xₖ, and is, for example, an L² norm, and ε is an index indicating the magnitude of the neighborhood. The distance is not limited to the L² norm but may be a function designed to perform another evaluation. As another example, the following equation may be used.

Dₙₑₐᵣₑₛₜ={(xₖ,yₖ)|a predetermined number of distances d(x*,xₖ) in order from the smaller one} (2)

As an example, the predetermined number may be set to about 100, but there is no restriction to this choice, and the predetermined number may be a larger value or a smaller value, such as 200 or 50. The predetermined number may be changed depending on the density of data, the size and type of data, or the like.

A neighborhood image may be extracted by using another method and be used as neighborhood (similar) data.

Each piece of data belonging to the extracted neighborhood data group is obtained as a set (xₙ, yₙ) including of input data xₙ of 8×8 pixels and output data yₙ of 32×32 pixels that is a high-resolution image of the input data.

Next, the initial value generator 106 generates an initial value of a learning model on the basis of the extracted neighborhood data group (step S104). In a case in which super resolution to be performed is designed to output a 32×32 pixels image from a input image of 8×8 pixels, its initial value is obtained on the assumption that a high resolution image of 32×32 pixels can be described by a simple model. As an example, it is expressed as follows. Note that, although the following equation is described by a linear model, the choice of the above simple model is not limited to a linear model.

yₙ=f(V,xₙ)+εₙ (3)

Here, yₙ is a 1024-dimensional vector representing the n-th high-resolution image of 32×32 pixels among the extracted neighborhood data group, xₙ is a 64-dimensional vector representing the low-resolution image of 8×8 pixels corresponding to the yₙ, f represents a transformation from xₙ to yₙ, and V represents its parameters. A vector εₙ represents an error between the linear model and the yₙ. As another example, in eq. 3, xₙ and yₙ may be expressed as a matrix instead of a vector. On the basis of the neighborhood data group, an initial value is generated for f satisfying such a relationship.

Depending on an algorithm used, the initial value may be generated by using another relationship, for example, eq. 4 described later, instead of a relationship of eq. 3. That is, the choice of the initial value here may be a value that indicates a relationship between xₙ and yₙ, and initial values may be generated of parameters and the like used in the learning of a transformation system. Specific examples of this step S104 and the next step S106 will be described later.

Next, using the initial value generated in step S104 (step S106), the learner 108 refines f by learning in such a way that eq. 3 is satisfied in the neighborhood data group. Since the initial value of the model is obtained from a neighborhood data group including of a relatively small number of target data, a problem of overfitting may occur. The learner 108 therefore refines the model given by the initial value by learning to obtain a model in which overfitting is avoided. The model to be refined can be, for example, a model that is locally linear and is compatible with a regularization method.

Next, the estimator 110 infers an output data y* that is a super-resolution image, by applying the local model learned by the learner 108 (step S108) to the target data x*. The outputter 112 appropriately outputs the output data y* that is inferred by the above series of processing steps.

“Initialization Example”

An example will be described for the initialization processing in step S104. Using the basis vectors, yₙ is expressed as follows.

yₙ=Vaₙ+εₙ (4)

Here, yₙ is a 1024-dimensional vector representing the n-th high-resolution image of 32×32 pixels among the extracted neighborhood data group, V is a matrix of 1024×K, aₙ is a K-dimensional vector, and εₙ is a 1024-dimensional vector. K represents the number of the basis vectors, V is an arranged set of K basis vectors representing the high-resolution image, and aₙ represents the weights of the respective basis vectors. An error vector representing the deviation from the model is represented by εₙ, and is assumed to follow a Gaussian distribution with a mean of zero and a variance σ².

The initial value generator 106 generates initial values of the transformation matrix V, the weight vector aₙ, and the variance σ². The initial values of the transformation matrix V and the weight vector aₙ may be obtained, for example, by performing principal component analysis (PCA) on the high-resolution image in the extracted neighborhood data group. An estimated value of the variance σ² may be obtained by an average of the square of the error (yₙ−V·aₙ)². The number of bases K may be a predetermined number or obtained as a value whose contribution rate in PCA is greater than or equal to a certain value.

“Learning Example 1”

Next, an example will be described for the learning processing in step S106. Approximate Bayesian estimation may be applied as an example. For example, in a local model for estimating a super-resolution image, a prior distribution may be set for the transformation matrix V or the weight vector aₙ, and a posterior distribution may be estimated by the variational Bayesian method. Alternatively, Gaussian noise may be added to the parameters of the initial model, multiples parameters may be generated, and estimation may be made by an ensemble thereof. A neural network whose intermediate layer is a single layer, or the like can be used as a more complicated model; however, learning of a complicated model takes time, so an appropriate model is to be selected with consideration to learning time and accuracy. A simple linear model obtained as an initial model maybe overfitted to the neighborhood data group. In order to avoid the overfitting, a regularization method (e.g. approximate Bayesian estimation) may be included as a part of the on-demand learning.

A transformation of xₙ by the transformation matrix V at parameters θ is represented as f(xₙ, θ), and a loss function in this case is represented as E(f(xₙ; θ), yₙ). The learner 108 is executed by obtaining θ that make E(·) smaller. That is, when the number of data belonging to the neighborhood data group is N, learning is performed by obtaining the parameters hat θ satisfying the following equation.

$$\hat{θ} = {argmin}_{θ} {\sum }_{n = 1}^{N} E ( f ( {x}_{n} ; θ ) , {y}_{n} ) \qquad ( 5 )$$

As an example, according to Bayesian estimation, learning is performed by following a probability distribution in the following equation when the models p(x, y|θ) and p(θ) are given. A predicted distribution of the output data yₙ in the input data xₙ and the set D is expressed by modeling a likelihood function p(y|x, θ).

$$\begin{matrix}p ( y \vert x , D ) = \int p ( y \vert x , θ ) p ( θ \vert x , D ) d θ & ( 6 ) \\ ln p ( D , θ \vert x ) = {\sum }_{n = 1}^{N} ( ln p ( {y}_{n} \vert {x}_{n} , θ ) ) + ln p ( θ ) + const . & ( 7 )\end{matrix}$$

The prior distribution p(θ) is predefined, and the posterior distribution p(θ|x, D) of the parameters θ is calculated from eq. 7 by an appropriate method and is assigned to the equation of eq. 6, whereby the predicted distribution of the output data y can be obtained. An appropriate method is, for example, a method of Gibbs sampling. As another example, there is a method of calculating basis vectors. Any method may be used as long as regularization is possible. Then, on the basis of the predicted distribution of eq. 6 obtained, an expected value E[y|x, D] of y is calculated.

Note that, eq. 7 can be expressed as follows upon the inclusion of the step of extracting the neighborhood data group, and it can be seen that learning is performed by using only data in the neighborhood of the target data in the supervised data storage 104.

$$ln p ( D , θ \vert x ) = {\sum }_{n = 1}^{N} K ( {x}_{n} , {x}^{*} ) ( ln p ( {y}_{n} \vert {x}_{n} , θ ) ) + ln p ( θ ) + const . \qquad ( 8 )$$

In eq.8, K(xₙ, x*) is a kernel function that is 1 when it is in the neighborhood of the target data x*, and 0 otherwise.

A large number of parameter candidates are expressed by a posterior distribution p(θ|x, D), an average of outputs based on the posterior distribution is calculated, and prediction is performed on the basis of the expected value of the predicted distribution. By the procedure described above, it is possible to suppress over-fitting that may occur when parameters are trained from a small number of data. The expected value E[y|x, D] can also be estimated by an ensemble as follows.

$$\begin{matrix}E [ y \vert x , D ] = \int {y}_{θ} p ( θ \vert x , D ) d θ & ( 9 ) \\ {y}_{θ} = \int yp ( y \vert x , θ ) dy & ( 10 ) \\ p ( y \vert x , θ ) = \frac{p ( y , x \vert θ )}{\int p ( y , x \vert θ ) dy} & ( 11 )\end{matrix}$$

Estimated values of the outputs under the parameters θ are represented by y_{θ}, and the average based on the posterior distribution of those outputs is the output to be produced.

“Learning Example 2”

In the aforementioned learning example 1, all the parameters are learned by Bayesian estimation; the parameters θ may be divided into sets of parameters ξ including one or more elements and parameters η including one or more elements, followed by a Bayesian estimation may be performed for the parameters ξ, and a point estimation based on maximum likelihood estimation may be performed for the parameters η. When the parameters θ are divided into two parameters as described above, that is, when θ=(ξ, η), the expected value E[·] can be expressed as follows.

E[y|x,D]=∫y_{ξ,\hat{η}}p(ξ|x,D,\hat{η})dξ (12)

However, in place of eq. 10, the following equation is applied.

y_{ξ,\hat{η}}=∫yp(y|x,θ=(ξ,\hat{η}))dy (13)

Here, the parameters η hat and the posterior distribution p(ξ|x, D, η hat) can be obtained on the basis of the following equations instead of eq. 5, eq. 8, and eq. 11.

$$\begin{matrix} \hat{η} = {argmax}_{η} ln p ( D \vert x , η ) + ln p ( η ) & ( 14 ) \\ p ( D \vert x , η ) = \int p ( D , ξ \vert x , η ) d ξ & ( 15 ) \\ ln p ( D , ξ \vert x , η ) = {\sum }_{n = 1}^{N} K ( {x}_{n} , {x}^{*} ) ( ln p ( {y}_{n} , {x}_{n} \vert ξ , n ) ) + ln p ( ξ ) + const . & ( 16 ) \\ p ( ξ \vert x , D , \hat{η} ) = \frac{p ( D , ξ \vert x , \hat{η} )}{\int p ( D , ξ \vert x , \hat{η} ) d ξ} & ( 17 )\end{matrix}$$

By using different algorithms for each parameter as described above, it is possible to balance the computational cost and the extent of the over-fitting.

As described above, according to the present embodiment, on demand data inference can be performed on big data irrespective of its size by using a data in the neighborhood of the target data instead of learning one inference model designed to describe the whole set. Further, by using approximate Bayesian estimation, it becomes possible to produce from local neighborhood dataset a model with high generalization ability as well as an ability to produce accurate inference for the target data. Once the target input data is passed to the system, this can be achieved by generating a local model based on the data in the neighborhood searched around the target data.

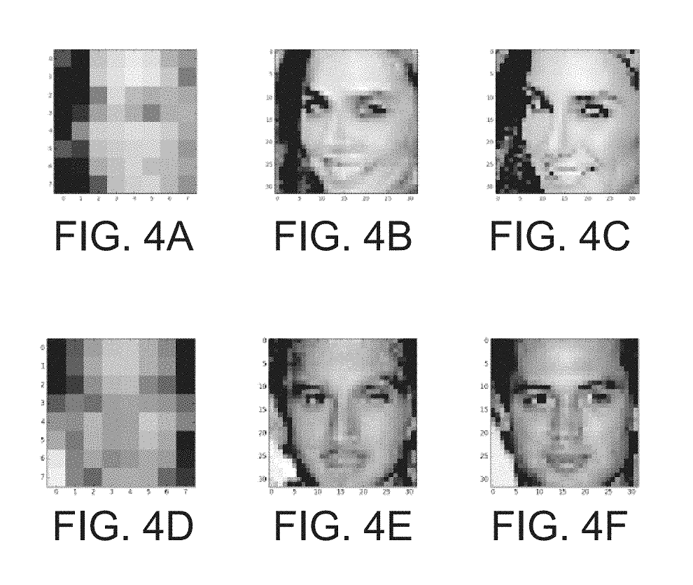

Hereinafter, as an example, a result will be described of super resolution by the data prediction apparatus 10 according to the present embodiment. FIGS. 4A to 4D are diagrams illustrating a result in which a super-resolution model is generated for the estimation of a high-resolution image from a low-resolution image according to the present embodiment.

A high-resolution image is represented by y, a low-resolution image is represented by x, and both are vectors obtained by arranging two-dimensional images in one dimension. As a model, it is assumed that the low-resolution image x is generated by applying a linear transformation on the high-resolution image y. In this modeling, a relationship between x and y can be expressed by the following equation.

x=Wy+m (18)

Here, W is a linear transformation representing a degradation process, and m is a Gaussian distribution with a mean of 0 and a variance σ². For example, when a pixel of 3×3 pixels in a high-resolution image is set as one low-resolution pixel, an average or weighted average of pixel values of the high resolution pixel of 3×3 is set to a pixel value of the low-resolution pixel. Linear transformation can be used to express many forms of corruption including bokeh and downsampling, and an appropriate function can be selected to model the actual degradation process.

On the other hand, it is assumed that the generated high-resolution image y is not an arbitrary image but a natural image having a specific property such as spatial smoothness, and can be locally expressed by the following equation in a locally low-rank vector space.

$$y = {\sum }_{k = 1}^{K} {a}_{k} {v}_{k} + n \qquad ( 19 )$$

Here, vₖ and aₖ are the k-th basis vector and the coefficient corresponding to the basis vector, respectively. It is assumed that n is a residual vector that cannot be represented in a K-dimensional vector space, and that it follows a Gaussian distribution with a mean of 0 and a variance of Σ.

In this way, the parameters θ are θ=(W, σ², {aₖ, vₖ|k=1, . . . , K}, τ). In the parameters, probability models p(x|y, θ) and p(y|θ) are defined under eq. 18 and eq. 19. From these, for example, it is defined as p(x, y|θ)=p(x|y, θ)p(y|θ).

FIG. 4A illustrates target data, FIG. 4B illustrates a high-resolution image estimated by the data prediction apparatus 10 according to the present embodiment, and FIG. 4C illustrates the true data. As described above, a high-resolution image with high accuracy can be inferred from the low-resolution image of FIG. 4A. The same applies to FIGS. 4D to 4F. FIG. 4D is the target data, FIG. 4E is the estimated data, and FIG. 4F is the true data.

In performing the data estimation of FIG. 4, instead of simply using a low-resolution image of 8×8 pixels, patches of 6×6 pixels are extracted from the image of 8×8 pixels, and nine pieces of target image data are generated from one piece of target image data.

Similarly, for each data stored in the supervised data storage 104, a low-resolution image of 6×6 pixels and a high-resolution image of 24×24 pixels of the corresponding range are generated. By making inferences to plural small patches contained in the target dataset, greater variety of low resolution images may be associated with the target dataset. Furthermore, the supervised dataset can be augmented by rotating the images.

For each patch of the target data, learning and estimation are performed on demand by the data prediction apparatus 10 described above. Then, a high-resolution image is obtained by synthesizing high-resolution patch images estimated from each patch.

As an example different from the above example, a variational Bayesian method may be used. The parameters θ may be divided into the parameters ξ={aₖ|k=1, . . . , K} for which Bayesian estimation is to be performed and the parameters η=(W, σ², {vₖ|k=1, . . . , K}, Σ) for which point estimation is to be performed. The parameter distribution p(ξ) may be set as an independent Gaussian for each component, and a variance of the Gaussian distributions may follow gamma distributions. Using variational Bayesian method, p(ξ|x, D, η) and η hat (η̂) are approximately calculated.

As still another example, learning may be performed locally by approximate Bayesian estimation using sampling. In the method using sampling, learning is performed by dividing the parameters θ into the parameters ξ={vₖ|k=1, . . . , K} for which Bayesian estimation is to be performed and the parameters q=(W, σ², {aₖ|k=1, . . . , K}, τ) for which point estimation is to be performed. For example, η hat is determined by principal component analysis. Also by principal component analysis, the basis {vₖ} can also be estimated by point estimation.

To approximately obtain the posterior distribution p(ξ|x, D, η hat) representing the uncertainty of the estimation, that is, the posterior distribution of the basis {vₖ}, Gaussian noise may be added to {v hatₖ) estimated by the point estimation via the principal component analysis. The Gaussian noise is determined on the basis of validation data, for example.

Simple expectation taken over the Gaussian noise will recover the basis obtained from the principal component analysis; however, when the expectation is empirically calculated from a finite number of samples, the obtained basis may not necessarily match the basis of the principal component analysis. Further, for example, when the high-resolution image is estimated by using a set of patch images as described above, an error of nature that is different from that of simple noise may occur in the overlap region among the plural patches.

As described above, in the data prediction apparatus 10 according to the present embodiment, it is possible to easily perform augmentation of the data in the neighborhood of the target data, and by performing data augmentation on the neighborhood data, it is possible to further improve the generalization performance and further perform highly accurate data estimation on the target data.

Note that, the data estimation has been described for super resolution of the low-resolution image, as an example; however, the application example of the present embodiment is not limited thereto. That is, it can also be applied to regression problems and identification problems (for example, identification of Higgs boson, character recognition, speech recognition, document analysis), and the like. Also, in regression problems or identification problems, a locally linear simple model is typically assumed. The above is an example, and application is possible to other locally simple models, for example, a neural network whose intermediate layer is a single layer.

As a learning method, Bayesian estimation has been cited; learning can be performed by a machine learning method that can obtain another type of local model while suppressing the overfitting. Also, it is possible to change the learning algorithm depending on the type of the data estimation described above.

In all the above descriptions, at least a part of the data prediction apparatus 10 may be configured by hardware (processing circuitry), or may be configured by software and implemented by a CPU or the like by software information processing. In a case where the processing circuitry is included in the apparatus, it is not necessary that all the functions are implemented on the same processing circuit, and it may be configured by changing the plurality of processing circuits depending on functions, modules, or other division methods. In a case where it is configured by the software, a program that implements at least a part of its functions of the data prediction apparatus 10 may be stored in a storage medium such as a flexible disk or CD-ROM, and may be executed by a computer that reads the program. By the software, the processing circuitry such as CPU may be operated in order to implement a part or all of the above functions. The storage medium is not limited to a detachable medium such as a magnetic disk or optical disk, and may be a fixed type storage medium such as a hard disk device or memory. That is, information processing by the software may be implemented by using hardware resources. Further, the processing by the software may be implemented in a circuitry such as an FPGA and executed by the hardware. Generation of the learning model and processing after the passing of the input to the learning model may be performed using an accelerator such as a GPU, for example. All functionalities described thereof can be distributed across one or plural processing circuitry in different locations.

The data estimation model according to the present embodiment can be used as a program module that is a part of artificial intelligence software. The CPU of the computer operates in order to perform the computation on the basis of the model stored in the storage and to output the result.

Those skilled in the art may conceive additions, effects, or various modifications of the present invention on the basis of all the above descriptions, but the aspects of the present invention are not limited to the individual embodiments described above. Various additions, modifications, and partial deletions are possible without departing from the conceptual idea and the gist of the present invention derived from the contents defined in the claims and their equivalents.

1. A data inference apparatus comprising:
a memory; and
processing circuitry coupled to the memory and configured to:
receive target data on which to make inference,
extract a neighborhood data group that is a set of data points in supervised data that are similar to the target data,
generate a local model by performing local and regularization learning using the neighborhood data group, and
make inference on the target data by using the local model.

2. The data inference apparatus according to claim 1, wherein the processing circuitry outputs result inferred from the target data.

3. The data inference apparatus according to claim 1, wherein the processing circuitry generates initial value from the neighborhood data group before performing learning.

4. The data inference apparatus according to claim 3, wherein the processing circuitry generates the initial value for learning the local model.

5. The data inference apparatus according to claim 1, wherein the processing circuitry performs learning by Bayesian estimation.

6. A data inference method comprising:
receiving, by processing circuitry, target data on which to make inference;
extracting, by the processing circuitry, a neighborhood data group that is a set of data points in the supervised data that are similar to the target data;
generating, by the processing circuitry, a local model by performing local and regularization learning using the neighborhood data group;
making, by the processing circuitry, inference on the target data by using the local model.

7. The data inference method according to claim 6, further comprising:
outputting, by the processing circuitry, result inferred from the target data.

8. The data inference method according to claim 6, wherein generating, by the processing circuitry, initial value from the neighborhood data group before performing learning.

9. The data inference method according to claim 8, wherein generating, by the processing circuitry, the initial value for learning the local model.

10. The data inference method according to claim 6, wherein performing, by the processing circuitry, learning by Bayesian estimation.

11. A non-transitory computer readable medium storing a computer readable program causing a computer to function as:
a section that receives target data on which to make inference;
a device that extracts a neighborhood data group that is a set of data points in the supervised data that are similar to the target data;
a section that generates a local model by performing local and regularization learning using the neighborhood data group;
a section that makes inference on the target data by using the local model.

12. The non-transitory computer readable medium according to claim 11, the program further causing the computer to function as:
a section that outputs result inferred from the target data.

13. The non-transitory computer readable medium according to claim 11, the program further causing the computer to function as:
a section that generates initial value from the neighborhood data group before performing learning.

14. The non-transitory computer readable medium according to claim 13, the program further causing the computer to function as:
a section that generates the initial value for learning the local model.

15. The non-transitory computer readable medium according to claim 11, the program further causing the computer to function as:
a section that performs learning by Bayesian estimation.
